(19) United States
(12) Patent Application Publication
(10) Pub. No.: US 2025/0375275 A1
(43) Pub. Date: Dec. 11, 2025

(54) METHOD OF PRODUCING A DENTAL OBJECT

(71) Applicant: Ivoclar Vivadent AG, Schaan (LI)

(72) Inventors: Jonas REINHARDT, Igis (CH); Christian NIEDRIG, Azmoos (CH); Nicola BITAR, Montlingen (CH); Christian RITZBERGER, Grabs (CH)

(21) Appl. No.: 19/231,833

(22) Filed: Jun. 9, 2025

(30) Foreign Application Priority Data
Jun. 10, 2024 (EP) 24181178.5

(51) Int. Cl. A61C 13/083; A61C 13/00

(52) U.S. Cl. CPC A61C 13/083; A61C 13/0019

(57) ABSTRACT

A method of producing a dental object (100), including the steps of printing (S101) the dental object by means of a production material and a support structure by means of a meltable support material layer by layer; melting (S102) the support material; and absorbing (S103) the molten support material in the production material of the printed dental object.

### CROSS-REFERENCE TO RELATED APPLICATIONS

This application claims priority to European patent application No. 24181178.5 filed on Jun. 10, 2024, which disclosure is incorporated herein by reference in its entirety.

### TECHNICAL FIELD

The present invention relates to a method of producing a dental object and a production system for producing a dental object layer by layer.

### SUMMARY

When producing a dental object using a 3D printing process, the printed dental object is subjected to very time-consuming polishing after a sintering process. A great deal of polishing is required here because the material is much harder after sintering. It is therefore advantageous to polish the object before sintering. Polishing in this state is easier and saves time. The layer thicknesses of the support and production material are not chosen too thick, so that the printing speed slows down. Higher print resolution reduces the polishing time, but the printing time is longer. The thinner the layers, the lower the surface roughness depending on the curvature. US2023158739 is directed to a system and method of making printed articles and is hereby incorporated by reference.

It is the technical task of the present invention to improve the production of a dental object.

This technical task is solved by subject-matter according to the independent claims. Technically advantageous embodiments are the subject-matter of the dependent claims, the description and the drawings.

According to a first aspect, the technical task is solved by a method of producing a dental object, comprising the steps of printing the dental object by means of a production material and a support structure by means of a meltable support material layer by layer; melting the support material; and absorbing the molten support material in the production material of the printed dental object. Absorbing can be achieved by infiltrating the molten support material or automatic absorption by an unavoidable infiltration by capillary forces.

The support material absorbed in the porous matrix of the production material achieves the technical advantage, for example, that the dental object is easier to handle, grind and polish, so that a smoother surface can be produced automatically. The process can, for example, save time that would normally have to be spent on polishing the printed and subsequently thermally compacted (sintered) dental object. The wax infiltration gives the unsintered dental object the necessary basic strength to allow polishing to be carried out in the unsintered state.

In a technically advantageous embodiment of the method, the production material comprises an oxide ceramic material. This achieves the technical advantage, for example, that a particularly suitable production material for dental objects is used.

In a further technically advantageous embodiment of the method, the support material comprises wax and/or non-ionic surfactants. Depending on their origin, waxes are divided into three main groups: natural waxes, wherein here again a distinction is made between vegetable and animal waxes, mineral waxes and petrochemical waxes; chemically modified waxes and synthetic waxes. In the present invention, petrochemical waxes, such as kerosene wax (hard kerosene), petrolatum, micro wax (micro kerosene) and mixtures thereof, particularly preferably kerosene wax, are preferably used. Vegetable waxes can also be used, e.g. candelilla wax, carnauba wax, Japan wax, esparto grass wax, cork wax, guaruma wax, rice germ oil wax, sugar cane wax, ouricury wax, montan wax; animal waxes, e.g. beeswax, shellac wax, spermaceti, lanolin (wool wax), brush grease; mineral waxes, e.g. ceresin, ozokerite (earth wax); chemically modified waxes, e.g. montan ester waxes, sasol waxes, hydrogenated jojoba waxes, or synthetic waxes, e.g. polyalkylene waxes, polyethylene glycol waxes. Non-ionic surfactants are, e.g., fatty alcohol ethoxylates, fatty alcohol propoxylates, alkyl glucosides, alkyl polyglucosides, octylphenoethoxylates, nonylphenoethoxylates. This achieves the technical advantage, for example, that a low melting point is achieved for the support material.

In a further technically advantageous embodiment of the method, after melting the support material is kept at a predetermined temperature for a predetermined infiltration time. The dental object can also be kept at this temperature. This achieves the technical advantage, for example, that the penetration of the support material into the porous dental object is facilitated. The porous dental object consists of individual particles, which form a compact molded body by building up and then drying the individual layers.

In a further technically advantageous embodiment of the method, the dental object is cooled or the temperature of the dental object is lowered after penetration of the support material. This achieves the technical advantage, for example, of increasing the processing speed of the method. The advantage of cooling is that it increases the strength of the printed dental object. This makes the dental object easier to handle and polish without causing cracks, flaking or damage.

In a further technically advantageous embodiment of the method, the dental object is ground or polished after penetration of the support material. This achieves the technical advantage, for example, of producing a smooth surface of the dental object in the green state.

In a further technically advantageous embodiment of the method, after printing a layer, the production material and/or the support material are cured and/or dried. This achieves the technical advantage, for example, that the production of the dental object is accelerated.

In a further technically advantageous embodiment of the method, the curing and/or drying of the production material and the support material is carried out by means of electromagnetic radiation, heat, an air flow, convection, evaporation and/or a chemical reaction. This achieves the technical advantage, for example, that the curing of the production material and the support material can be carried out particularly efficiently.

In a further technically advantageous embodiment of the method, the molten support material only partially penetrates into the dental object. This achieves the technical advantage, for example, that only the outer layers of the dental object are infiltrated with the support material and support material can be saved and the subsequent process can be carried out more quickly, such as sintering or debinding.

In a further technically advantageous embodiment of the method, the support material comprises a doping material that changes the properties of the dental object during sintering. The doping material is, for example, yttrium, lanthanum, iron, manganese, chromium, erbium, terbium, praseodymium, neodymium, cobalt, nickel, titanium in ionically dissolved form (such as Y³⁺, La³⁺, Ce³⁺, Ce⁴⁺, Fe³⁺, Er³⁺) or as nanoparticles in the form of oxides <100 nm (Y₂O₃, Tb₂O₃, Mn₂O₃, Fe₂O₃, Pr₂O₃, Er₂O₃). This achieves the technical advantage, for example, that the optical properties of the dental object and the compaction behavior can be further improved in a subsequent sintering process.

In a further technically advantageous embodiment of the method, the support material comprises glass or glaze material or glass or glaze nanomaterial with an average particle size d₅₀ of 0.01-10 μm, preferably 0.01-5 μm. The glass or glaze material has a viscosity of greater than 102.5 Pa·s in a temperature range of 950° C.-1300° C. As a rule, the glass or glaze material has a viscosity of less than 109 Pa·s at 1450° C. Preferred glass or glaze materials have a viscosity of 104 Pa·s at 950° C., preferably 105.6 Pa·s and particularly preferably 107 Pa·s, and a preferred viscosity of 104 Pa·s at 1300° C. and/or a viscosity of less than 107 Pa·s and preferably less than 105.6 Pa·s at 1450° C. This achieves the technical advantage that the capillary forces of the printed dental object form a thin layer of the glass or glaze material on the surface and form a dense glaze layer during the final sintering to full density of the dental object.

In a further technically advantageous embodiment of the method, the dental object is a crown, a bridge, an abutment, a veneer, an inlay, an onlay, a table top, a partial or full prosthesis. This achieves the technical advantage, for example, that particularly suitable dental objects are produced.

In a further technically advantageous embodiment of the method, the support material is melted in the printer or on the build platform after printing. The infiltration or melting of the wax can also be carried out outside the printer, for example in a furnace. This achieves the technical advantage, for example, that the support material can be absorbed immediately.

According to a second aspect, the technical task is solved by a production system for producing a dental object layer by layer, comprising a print head for printing the dental object by means of a production material and a support structure by means of a meltable support material layer by layer; and a melting device for melting the support material. This achieves the same technical advantages as the method according to the first aspect.

In a technically advantageous embodiment of the production system, the melting device is configured to keep the support material at a predetermined temperature for a predetermined infiltration time. This achieves the technical advantage, for example, that the penetration of the support material into the dental object is facilitated.

In a further technically advantageous embodiment of the production system, the production system comprises a cooling device for cooling the dental object. This achieves the technical advantage, for example, that the processing speed of the production system is improved.

In a further technically advantageous embodiment of the production system, the production system comprises a finishing device for grinding or polishing the dental object. This achieves the technical advantage, for example, that a particularly smooth surface of the dental object can be produced with the production system.

### BRIEF DESCRIPTION OF THE DRAWINGS

Exemplary embodiments of the invention are shown in the drawings and are described in more detail below, in which:

FIG. 1 shows a schematic view of a production system for producing a dental object;

FIG. 2 shows a further schematic view of the production system for producing the dental object; and

FIG. 3 shows a block diagram of a method of producing a dental object.

### DETAILED DESCRIPTION

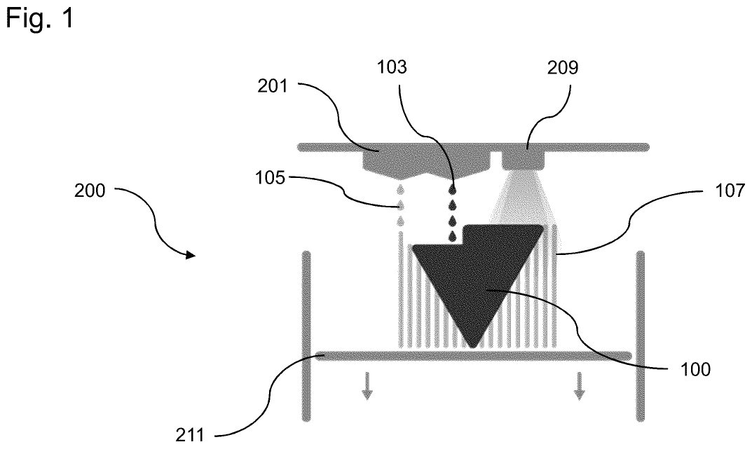

FIG. 1 shows a schematic view of a production system 200 for producing a printed dental object 100. The dental object 100 is, for example, a crown, a bridge, an abutment, a veneer, an inlay, an onlay, a table top, a partial or full prosthesis. Such dental objects 100, which are implemented in a patient's mouth, should have a smooth surface, as otherwise wearing comfort is low. A rough surface of the dental object 100 also promotes the growth of an undesirable biofilm and discoloration is more pronounced.

For production, a three-dimensional model of the desired dental object 100 is first created in a CAD program and divided into digital layers (slices). Each slice represents a thin horizontal cross-section of the dental object 100.

The software of the production system 200, such as a 3D jet printer, prepares the data and controls the print head 201, the platform 211 and the support material 105 and production material 103. The 3D jet printer is, for example, an inkjet or MJ printer.

The production material 103, such as a ceramic slurry, is used to build up the dental object 100. The support material 105, such as wax, is used to build up support structures 107 on which overhangs of the dental object 100 can be supported. The support material 105 is removed after the printing process.

In addition, parameters are determined, such as printing speed, layer thickness and material feed. Further process parameters are, for example, a substrate temperature, a temperature of the support material 105 and a temperature of the drying or evaporation device 209 for removing a solvent, such as water.

A green part of the dental object 100 is then created in the production system 200 by applying drops of the production material 103 layer by layer. The green part is the printed object in the state before sintering. The print head 201 moves over the platform 211 and sprays tiny drops of the production material 103 and the support material 105 onto the surface. The platform 211 can also move under the print head 201.

The process is similar to conventional inkjet printing, in which drops of ink are applied to paper or another surface. In the 3D-jet printing process, however, this process is repeated in the third dimension with the production material 103 in order to spatially produce the three-dimensional dental object 100.

After the application of each layer, both the production material 103 and the support material 105 are cured or dried. This may be accomplished by electromagnetic radiation, heat, an air flow with adjustable temperature, humidity and/or velocity, or a chemical reaction, depending on the specific properties of the respective materials. Most of the drying and solidification is accomplished by removing the water from the printed dental object 100 during printing. After printing, a certain amount of residual water can still be evaporated from the dental object 100 so that infiltration of the porous structure is possible.

The production material comprises oxide ceramic particles, a solvent, dispersant and/or a sedimentation additive. Oxide ceramic particles are, for example, yttrium-stabilized zirconium dioxide. Solvents are, for example, polar and non-polar solvents, such as water, alcohols, glycols and mixtures thereof. A dispersant comprises, for example, carboxylic acids, amines or amino alcohols. Sedimentation additives are, for example, polysaccharides, cellulose and derivatives.

After completion of the printing process and curing, support material 105 is partially removed. This can be done by temperature, electromagnetic radiation, heated air, water, solvent or mechanical removal.

However, when a dental object 100 is printed together with a support material 105, a rough surface is created on the printed dental object 100. This roughness of the surface is created by the quantization of the printed voxels or layers. Due to a stair-stepping effect, the space between the voxels means that the edges of the dental object 100 printed layer by layer are not smooth, but appear stair-stepped. This makes the surface of the dental object 100 uneven and rough.

This means that the dental object 100 is ground and polished again after the debinding and sintering process in order to obtain a pleasant oral product for the user. After sintering, the oxide ceramic of the dental object 100 has a high strength. However, this makes grinding and/or polishing difficult and time-consuming. Pre-polishing in the unsintered state (green state) is therefore advantageous. Pre-polishing reduces the time and effort required for final polishing in the densely sintered state many times over.

For this purpose, the meltable support material 105 is used in the method. When the previously manufactured support structures 107 are melted, the support material 105 used penetrates partially or completely into the ceramic dental object 100 by capillary action and is absorbed therein. During infiltration, the porous ceramic of the dental object 100 absorbs the liquid support material 105 so that the cavities are filled and the density and strength are increased. This is possible because the printed dental object 100 has pore sizes in the nanometer to micrometer range. In this method, the support material 105 is heated after printing and kept above the melting temperature for a predetermined infiltration time so that the liquid support material 105 can penetrate into the printed dental object 100. The capillary forces determine how deep the liquid support material 105 penetrates into the dental object 100.

During the subsequent cooling of the dental object 100, the support material 105 remaining in the dental object 100 solidifies. The solidification of the support material 105 in the dental object 100 increases its strength, which would not be present without infiltration. This strength now makes it possible to pre-polish the surface of the printed dental object 100 without generating stresses that could lead to destruction of the dental object 100. The infiltrated dental object 100 has better mechanical strength, which enables pre-polishing before the sintering process.

If, on the other hand, no infiltration is carried out, the printed dental object 100 has poorer mechanical properties. In this case, parts of the printed dental object 100 may break off or develop cracks. This results in the printed dental object 100 being unusable or of reduced quality.

Pre-polishing before the sintering process is more efficient than complete polishing afterwards, resulting in time savings in the production of the dental object 100. Pre-polishing also reduces the surface roughness in the printed preliminary state. In the final sintered state, therefore, only a fine polish needs to be carried out.

In addition, it is possible to add further soluble, ionogenic sintering materials, such as dyes or other substances, to the support material 105 so that these are also absorbed during the infiltration of the dental object 100. This makes it possible, for example, to create an outer more translucent layer in the dental object 100 during sintering or to specifically adjust other properties, such as a color of the dental object 100. This also makes it possible to subsequently introduce color gradients into the printed dental object 100.

This method ensures better and faster handling of the production. Less consumables are required, such as milling cutters or polishers. The finishing time can be reduced by 80%. On the tool side, the service life of a diamond milling cutter and polisher is extended by a factor of 20.

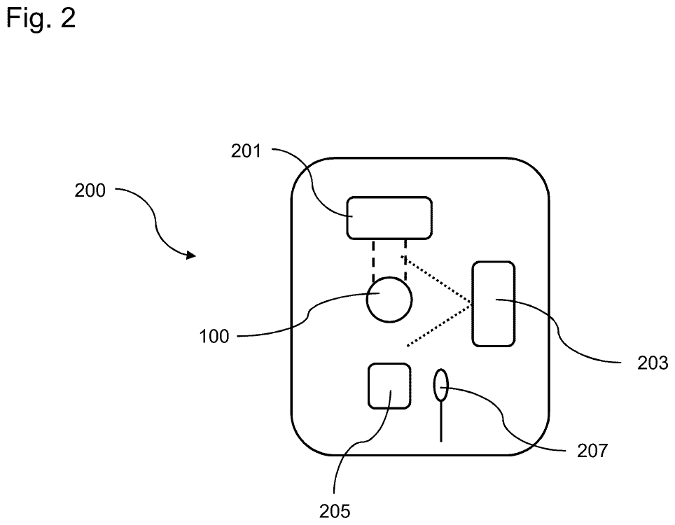

FIG. 2 shows a further schematic view of the production system 200 for producing the dental object 100 layer by layer. The production system 200 comprises the print head 201 for printing the dental object 100 by means of the production material 103 and for printing the support structure 107 by means of the meltable support material 105 layer by layer. In this production process, the support material 105, which can be liquefied depending on the temperature, is also printed in order to produce the support structure 107 for overhanging areas.

A melting device 203 is used for the subsequent melting of the support material 105 of the support structure 107. The melting device 203 is configured to keep the support material 105 at a predetermined temperature for a predetermined infiltration time. The melting device is, for example, a furnace, a heater or a blower.

In addition, the production system 200 comprises a cooling device 205 for cooling the dental object 100. The cooling device 205 cures the infiltrated support material 105, for example by cooling, to form a solid matrix within the dental object 100. Normal cooling to room temperature without technical aids can also take place.

In order to further accelerate the production process, the production system may comprise a finishing device 207 for grinding or polishing the dental object 100. This achieves the advantage that all work steps can be carried out by the production system 200. The different devices of the production system 200 can be combined in one device or can be spatially separated and arranged at different locations.

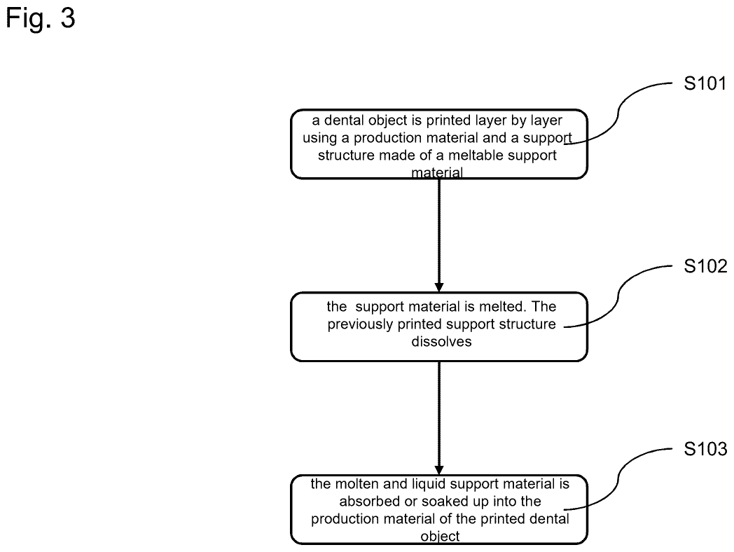

FIG. 3 shows a block diagram of a method of producing the dental object 100. In step S101, the dental object 100 is printed by means of the production material 103 and the support structure 107 by means of the meltable support material 105 layer by layer. In step S102, the support material 105 is melted. The previously printed support structure dissolves. In step S103, the molten and liquid support material 105 is absorbed or soaked up into the production material 103 of the printed dental object 100.

After the support material 105 has infiltrated and cured, the surface of the printed dental object 100 is finished before sintering in order to achieve the desired surface finish. Finally, in a final treatment, the finished dental object 100 can be subjected to further processes such as grinding, polishing or coating, depending on the application requirements, to obtain its final shape and surface finish.

The penetrated support material 105 forms an outer and inner support structure inside the dental object 100. The outer support structure stabilizes the geometry or outer geometry and ensures the dimensional stability of the dental object 100. The inner support structure increases the strength of the dental object 100 and improves the overall handling, even if the outer support structure has been removed again.

All the features explained and shown in connection with individual embodiments of the invention can be provided in different combinations in the subject-matter according to the invention in order to simultaneously realize their advantageous effects.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### REFERENCE LIST

100 Dental object
103 Production material
105 Support material
107 Support structure
200 Production system
201 Print head
203 Melting device
205 Cooling device
207 Finishing device
209 Drying or evaporation device
211 Platform

1. A method of producing a dental object, comprising the steps of:
printing the dental object layer by layer using a production material and a support structure comprising a meltable support material;
melting the support material; and
absorbing the molten support material in the production material of the printed dental object.

2. The method according to claim 1, wherein the production material comprises an oxide ceramic material.

3. The method according to claim 1, wherein the support material comprises waxes and/or non-ionic surfactants.

4. The method according to claim 1, wherein, after melting, the support material is kept at a predetermined temperature for a predetermined infiltration time.

5. The method according to claim 1, wherein the dental object is cooled or the temperature of the dental object is lowered after penetration of the support material.

6. The method according to claim 1, wherein the dental object is ground or polished after penetration of the support material.

7. The method according to claim 1, wherein after printing a layer, the production material and/or the support material are cured and/or dried.

8. The method according to claim 7, wherein the curing and/or drying of the production material and the support material is carried out by means of electromagnetic radiation, ultraviolet light, heat, an air flow, convection, evaporation and/or a chemical reaction.

9. The method according to claim 1, wherein the molten support material only partially penetrates into the dental object.

10. The method according to claim 1, wherein the support material comprises a doping material that changes the properties of the dental object during sintering or wherein the support material comprises glass or glaze material.

11. The method according to claim 1, wherein the dental object is a crown, a bridge, an abutment, a veneer, an inlay, an onlay, a table top, a partial or full prosthesis.

12. A production system for producing a dental object layer by layer, comprising:
a print head for printing the dental object layer by layer using a production material and a support structure comprising a meltable support material; and
a melting device for melting the support material.

13. The production system according to claim 12, wherein the melting device is configured to keep the support material at a predetermined temperature for a predetermined infiltration time.

14. The production system according to claim 13, wherein the production system comprises a cooling device for cooling the dental object.

15. The production system according to claim 12, wherein the production system comprises a finishing device for grinding or polishing the dental object.
